(19) United States
(12) Patent Application Publication
(10) Pub. No.: US 2025/0190324 A1
(43) Pub. Date: Jun. 12, 2025

(54) CONTEXT-BASED MANAGEMENT OF SYSTEM PERFORMANCE

(71) Applicant: DELL PRODUCTS L.P., Round Rock, TX (US)

(72) Inventors: Karunakar Palicherla Reddy, Austin, TX (US); Fnu Jasleen, Austin, TX (US)

(73) Assignee: DELL PRODUCTS L.P., Round Rock, TX (US)

(21) Appl. No.: 18/536,718

(22) Filed: Dec. 12, 2023

(51) Int. Cl. G06F 11/34; G06F 1/20; G06F 9/30; G06F 11/30

(52) U.S. Cl. CPC G06F 11/3466; G06F 1/206; G06F 9/30083; G06F 11/3003; G06F 11/3051; G06F 11/3055; G06F 11/3096; G06F 11/3438; G06F 2201/86

(57) ABSTRACT

Techniques for managing the performance of a computer system based on context are described. One example method includes identifying a fan noise level associated with an integrated fan of the computer system based on sound input detected by an audio input device associated with the computer system; identifying a current context associated with the computer system; determining that the identified fan noise level is undesirable for the current context; and in response to determining that the identified fan noise level is undesirable, performing modifications to operations of the computer system, wherein the modifications are adapted to reduce an operating speed of the integrated fan.

### TECHNICAL FIELD

The present disclosure relates in general to information handling systems, and more particularly to techniques for management of information handling systems.

### BACKGROUND OF THE INVENTION

Computer systems generally include a variety of electronic components that generate heat in operation, such as, for example, a processor. In order to prevent this generated heat from damaging the electronic components, computer systems generally including cooling systems to remove the generated heat and keep the electronic components at safe operating temperatures. One common cooling system includes a fan (or multiple fans) configured to draw cooler air into particular areas of the housing of the computer from the outside, and to expel warm air from inside the housing to the outside. Generally, in the case of a processor, the higher its usage (i.e., the number of instructions it is executing per unit time) the more heat it will generate. When more heat is generated the fan may be operated at a higher speed in order to circulate more air and thus dissipate more heat. In general, increasing the fan speed will increase the amount of audible noise produced by the fan. This noise can be disruptive or distracting to users of the computer system engaged with particular types of applications, such as voice communication or other applications that are sensitive to environmental noise.

In addition, many computer systems can detect the physical presence of a user near the system. This ability to detect user presence can allow the system to be contextually aware of user's proximity to the system, the user's attention to the system, the environment in which the user is using the system, and other information. For example, a system can automatically wake up from a low power state in response to detecting the presence of a user, and can initiate facial recognition to verify the user's identity to quickly log them into the system. A system can also lock itself when it detects that no user is present. User presence can be detected, for example, by analyzing captured video signals from a low power camera device, audio signals from a microphone, or other signals or combinations of signals.

### SUMMARY OF THE INVENTION

In accordance with embodiments of the present disclosure, a method for managing the performance of a computer system based on context includes identifying a fan noise level associated with an integrated fan of the computer system based on sound input detected by an audio input device associated with the computer system; identifying a current context associated with the computer system; determining that the identified fan noise level is undesirable for the current context; and in response to determining that the identified fan noise level is undesirable, performing modifications to operations of the computer system, wherein the modifications are adapted to reduce an operating speed of the integrated fan.

In some implementations, identifying the current context includes identifying a presence of a user in front of the computer system.

In some cases, identifying the presence of the user is performed based on input captured by a camera associated with the computer system.

In some cases, identifying the current context includes identifying a status of a particular software application being executed by the computer system.

In some implementations, the particular software application is a voice communication application, and wherein the identified status indicates that a voice communication session is currently active.

In some implementations, the modifications to operations of the computer system include suspending background tasks being executed by the computer system.

In some cases, the modifications to operations of the computer system include modifying an Energy Performance Preference (EPP) parameter of a processor of the computer system to reduce a maximum speed of the processor.

In some cases, in response to performing the modifications to the operations of the computer system, it is verified that a current fan noise level associated with the integrated fan of the computer system is less than the identified fan noise level.

In accordance with embodiments of the present disclosure, a system for managing computer system performance based on context, the system includes a computer system including at least one processor, a memory, and an integrated fan. The system is configured to identify a fan noise level associated with the integrated fan based on sound input detected by an audio input device associated with the computer system; identify a current context associated with the computer system; determine that the identified fan noise level is undesirable for the current context; and in response to determining that the identified fan noise level is undesirable, perform modifications to operations of the computer system, wherein the modifications are adapted to reduce an operating speed of the integrated fan.

In accordance with embodiments of the present disclosure, an article of manufacture includes a non-transitory, computer-readable medium having computer-executable instructions thereon that are executable by a processor to perform operations for managing the performance of a computer system based on context. The operations include identifying a fan noise level associated with an integrated fan of the computer system based on sound input detected by an audio input device associated with the computer system; identifying a current context associated with the computer system; determining that the identified fan noise level is undesirable for the current context; and in response to determining that the identified fan noise level is undesirable, performing modifications to operations of the computer system, wherein the modifications are adapted to reduce an operating speed of the integrated fan.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example process for context-based management of system performance, in accordance with embodiments of the present disclosure.

### DETAILED DESCRIPTION OF THE INVENTION

As described above, high usage rates in components of a computer system such as a processor may lead to increased heat generation, which may necessitate that a cooling fan of the computer system be run at a higher speed. This increased fan speed may lead to an increase in the noise generated by the fan. This fan noise can be disruptive or distracting to users of the computer system engaged with particular types of applications, such as voice communication or other applications that are sensitive to environmental noise. Reducing the usage rates of the components, such as the processor, will generally lead to a reduction in the amount of heat generated. This reduction in the generated heat will enable the fan speed to be reduced, which will generally lead to a decrease in the noise level produced by the fan.

However, reducing the usage rate of the components of the system by, for example, reducing the clock speed of the processor or suspending applications that are causing high processor usage, may be inefficient if performed in all circumstances. For example, if no user is present at the computer system, or no user is currently using an application that is likely to be disrupted by increased fan noise, reducing the usage rate may not be necessary because the increased fan noise is not adversely affecting any user of the system.

To address these issues, the present disclosure generally describes techniques for context-based management of system performance, and more particularly techniques for managing system performance (and thus generated fan noise) based on contextual factors, such as the presence of a user at the computer system and the current operational state of the computer system (e.g., what applications are currently being used by the detected user).

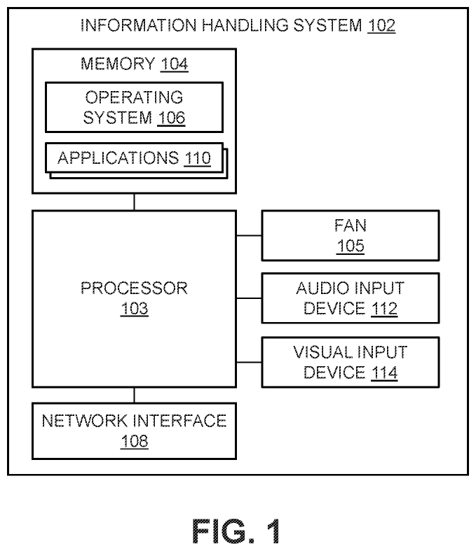

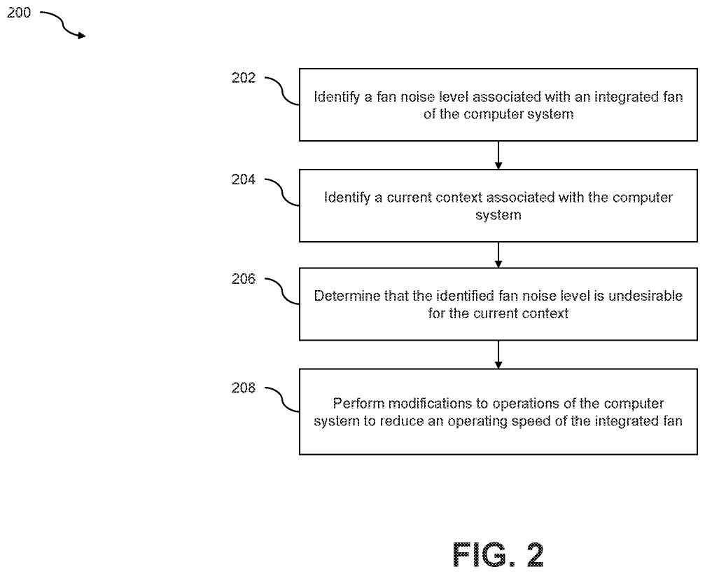

Preferred embodiments and their advantages are best understood by reference to FIGS. 1 and 2, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a fan 105 coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Memory 104 may also have stored thereon one or more applications 110. Each of the applications 110 may comprise any program of executable instructions (or aggregation of programs of executable instructions) configured to make use of the hardware resources of the information handling system 102, such as memory, processor time, disk space, input and output devices (e.g., 112, 114), and the like. In some implementations, the applications 110 may interact with the operating system 106 to make of the hardware resources, and the operating system 106 may manage and control the access of the applications 110 to these resources (as described above).

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In some embodiments, information handling system 102 may include more than one processor 103. For example, one such processor 103 may be a CPU, and other processors 103 may include various other processing cores such as application processing units (APUs) and graphics processing units (GPUs).

As shown, information handling system 102 also includes a fan 105, which is positioned adjacent to or coupled to processor 103. The fan 105 is configured to draw cooler air into particular areas of the housing of the information handling system 102 from the outside, and to expel warm air from inside the housing to the outside. In some configurations, the fan 105 may be configured to move air across a heat sink to cool a particular component, such as, for example the processor 103. The fan 105 may be configured to operate at different speeds in order to provide different amounts of cooling under different circumstances. For example, when the processor 103 is at a high usage level, it will produce more heat. In such a case, the fan 105 may be operated at a higher speed in order to more effectively cool the processor 103 in order to keep its temperature within a predetermined temperature range. Conversely, when the processor 103 is at a lower usage level, it will produce less heat. In such a case, the fan 105 may be operated at a lower speed in order to, for example, conserve power. Operating fan 105 at a higher speed is generally associated with an increased noise level when perceived by a user present at information handling system 102, while operating fan 105 is generally associated with a lower noise level.

Information handling system 102 further includes an audio input device 112 communicatively coupled to processor 103. Audio input device 112 can be any device (e.g., a microphone) operable to detect audible signals (i.e., sound waves) in the environment external to the information handling system 102, and convert those audible signals into electrical signals. These electrical signals representing the detected audible signals can be provided to the processor 103 where they can be analyzed and interpreted, for example at the direction of applications 110 and/or operating system 106. In some cases, the audio input device 112 can be integrated into the information handling system 102, such as in the case of a built-in microphone. The audio input device 112 may also be an external device communicatively coupled to the information handling system 102, such as an external microphone connected via Universal Serial Bus (USB).

Information handling system 102 further includes an visual input device 114 communicatively coupled to processor 103. Visual input device 114 can be any device operable to detect electromagnetic radiation, such as visible light, and convert it into representative electrical signals. These electrical signals representing the detected electromagnetic radiation can be provided to the processor 103 where they can be analyzed and interpreted, for example at the direction of applications 110 and/or operating system 106. In some cases, the visual input device 114 can be complementary metal-oxide-semiconductor (CMOS) sensor, a charge coupled device (CCD) sensor, or another type of sensor operable to detect electromagnetic radiation. In some implementations, the visual input device 114 may be configured to detect a particular range of wavelengths of electromagnetic radiation, such as the visual light range, the ultraviolet range, the infrared range, or combinations of these and other ranges. In some cases, the visual input device 114 may be a low power camera device that monitors the environment while the information handling system 102 remains in a lower power state. In some implementations, the visual input device 114 can be integrated into the information handling system 102, such as in the case of a built-in camera. The visual input device 114 may also be an external device communicatively coupled to the information handling system 102, such as an external camera connected via USB.

FIG. 2 illustrates a flow chart of an example process 200 for context-based management of system performance, in accordance with embodiments of the present disclosure. The process 200 may be performed by a computer system, such as information handling system 102 described above.

At 202, a fan noise level associated with an integrated fan of the computer system is identified based on audio signals detected by an audio input device associated with the computer system. For example, the computer system may analyze the audio signals in order to distinguish noise generated by the integrated fan from other system generated noise, such as, for example, conferencing or external voices of persons or devices, typing by the user, or other sources. In some implementations, an artificial neural network or other type of machine learning model that has been trained to distinguish noise generated by the integrated fan from that generated by other sources is used to distinguish the fan noise.

At 204, a current context associated with the computer system is identified. In some cases, identifying the current context includes identifying a presence of a user in front of the computer system, for example, based on visual input signals from a visual input device (e.g., device 114 in FIG. 1), or other input signals. In some implementations, the visual input signals are analyzed by a software application to determine user presence, for example, by detecting the presence of a user in the scene represented by the visual input signals. In some cases, an artificial neural network or other type of artificial intelligence (AI) model that has been trained to identify user presence based visual input signals is used to perform this determination. In some cases, the current context may include whether a user whose presence has been detected is a registered user or not.

In some cases, identifying the current context includes identifying a status of a particular software application being executed by the computer system. In some cases, the particular software application may be a voice communication application, and the identified status may indicate that a voice communication session is currently active.

At 206, it is determined that the identified fan noise level is undesirable for the current context. For example, a fan noise level above a particular threshold may be determined to be undesirable if a user is present and engaged in a voice call using a voice communication application executed by the computer system. However, the same fan noise level may not be determined to be undesirable if no user is present at the computer system, because the fan noise is not disrupting any ongoing user activity.

At 208, in response to determining that the identified fan noise level is undesirable, modifications to operations of the computer system are performed in order to reduce an operating speed of the integrated fan, and thereby reduce the noise level associated with the operation of the fan. In some cases, the modifications to operations of the computer system include suspending background tasks being executed by the computer system. In some implementations, the modifications to operations of the computer system include modifying an Energy Performance Preference (EPP) parameter of a processor of the computer system to reduce a maximum speed of the processor, which will generally lead to the processor producing less heat, the fan slowing down, and a reduction in the fan noise level.

In some cases, in response to performing the modifications to the operations of the computer system, the computer system may verify that a current fan noise level associated with the integrated fan of the computer system is less than the identified fan noise level.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may one or more processing resources such as a include memory, central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for managing the performance of a computer system based on context comprising:
identifying a fan noise level associated with an integrated fan of the computer system based on sound input detected by an audio input device associated with the computer system;
identifying a current context associated with the computer system;
determining that the identified fan noise level is undesirable for the current context; and
in response to determining that the identified fan noise level is undesirable, performing modifications to operations of the computer system, wherein the modifications are adapted to reduce an operating speed of the integrated fan.

2. The method of claim 1, wherein identifying the current context includes identifying a presence of a user in front of the computer system.

3. The method of claim 2, wherein identifying the presence of the user is performed based on input captured by a camera associated with the computer system.

4. The method of claim 1, wherein identifying the current context includes identifying a status of a particular software application being executed by the computer system.

5. The method of claim 4, wherein the particular software application is a voice communication application, and wherein the identified status s indicates that a voice communication session is currently active.

6. The method of claim 1, wherein the modifications to operations of the computer system include suspending background tasks being executed by the computer system.

7. The method of claim 1, wherein the modifications to operations of the computer system include modifying an Energy Performance Preference (EPP) parameter of a processor of the computer system to reduce a maximum speed of the processor.

8. The method of claim 1, further comprising:
in response to performing the modifications to the operations of the computer system, verifying that a current fan noise level associated with the integrated fan of the computer system is less than the identified fan noise level.

9. A system for managing computer system performance based on context, the system comprising:
a computer system including at least one processor, a memory, and an integrated fan, and configured to perform operations including:
identifying a fan noise level associated with the integrated fan based on sound input detected by an audio input device associated with the computer system;
identifying a current context associated with the computer system;
determining that the identified fan noise level is undesirable for the current context; and
in response to determining that the identified fan noise level is undesirable, performing modifications to operations computer system, wherein the of the modifications are adapted to reduce an operating speed of the integrated fan.

10. The system of claim 9, wherein identifying the current context includes identifying a presence of a user in front of the computer system.

11. The system of claim 10, wherein identifying the presence of the user is performed based on input captured by a camera associated with the computer system.

12. The system of claim 9, wherein identifying the current context includes identifying a status of a particular software application being executed by the computer system.

13. The system of claim 12, wherein the particular software application is a voice communication application, and wherein the identified status indicates that a voice communication session is currently active.

14. The system of claim 9, wherein the modifications to operations of the computer system include suspending background tasks being executed by the computer system.

15. The system of claim 9, wherein the modifications to operations of the computer system include modifying an Energy Performance Preference (EPP) parameter of a processor of the computer system to reduce a maximum speed of the processor.

16. The system of claim 9, the operations further comprising:
in response to performing the modifications to the operations of the computer system, verifying that a current fan noise level associated with the integrated fan of the computer system is less than the identified fan noise level.

17. An article of manufacture comprising a non-transitory, computer-readable medium having computer-executable instructions thereon that are executable by a processor to perform operations for managing the performance of a computer system based on context, the operations comprising:
identifying a fan noise level associated with an integrated fan of the computer system based on sound input detected by an audio input device associated with the computer system;
identifying a current context associated with the computer system;
determining that the identified fan noise level is undesirable for the current context; and
in response to determining that the identified fan noise level is undesirable, performing modifications to operations of the computer system, wherein the modifications are adapted to reduce an operating speed of the integrated fan.

18. The article of claim 17, wherein identifying the current context includes identifying a presence of a user in front of the computer system.

19. The article of claim 18, wherein identifying the presence of the user is performed based on input captured by a camera associated with the computer system.

20. The article of claim 17, wherein identifying the current context includes identifying a status of a particular software application being executed by the computer system.
